(19) United States
(12) Patent Application Publication
(10) Pub. No.: US 2008/0302203 A1
(43) Pub. Date: Dec. 11, 2008

(54) Gear Shift Lever Assembly for a Transmission of a Motor Vehicle

(75) Inventors: Manfred Dorn, Stuttgart (DE); Ulrich Lasi, Herrenberg (DE); Joern Petersen, Stuttgart (DE); Gerhard Seidel, Denkendorf (DE); Stefan Sielaff, Muenchen (DE); Josef Stuempel, Borchen (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/915,066

(22) PCT Filed: May 17, 2006
(86) PCT No.: PCT/EP2006/004676

§ 371 Date: Jun. 25, 2008

(30) Foreign Application Priority Data
May 20, 2005 (DE) 10 2005 023 968.4

(51) Int. Cl. G05G 1/04

(52) U.S. Cl. 74/507

(57) ABSTRACT

The invention relates to a shift lever arrangement for a transmission of a motor vehicle having a shift lever for setting a selected shift stage of the transmission, with the shift lever being mounted, by means of a positioning unit, so as to be movable between a non-use position of the shift lever and a use position thereof for setting the shift stages and/or vice versa, wherein an anti-trap unit is assigned to the shift lever, in such a way that, after the activation of the positioning unit for adjusting the shift lever between the non-use position and the use position thereof and/or vice versa, the positioning force generated by the positioning unit and acting on the shift lever can be at least reduced.

### BACKGROUND AND SUMMARY OF THE INVENTION

This invention relates to a shift lever arrangement for a transmission of a motor vehicle having a shift lever for setting a selected shift stage of the transmission, with the shift lever being mounted, by way of a positioning unit, so as to be movable between a non-use position of the shift lever and a use position thereof for setting the shift stages and/or vice versa.

German document DE 197 46 438 A1 discloses a shift lever arrangement for a transmission of a motor vehicle, in which, by means of a positioning unit, a shift lever which serves for setting a selected shift stage of the transmission is mounted so as to be movable between a non-use position of the shift lever and a use position thereof. Safety measures, which protect the user of the motor vehicle from an undesired injury as a result of becoming trapped during a movement of the shift lever, are not provided.

It is an object of the present invention to further develop a shift lever arrangement for a transmission of a motor vehicle in such a way that the risk of injury to the user during a movement of the shift lever from a non-use position into a use position and vice versa is reduced.

To achieve this object, the invention has an anti-trap unit assigned to the shift lever in such a way that, after the activation of the positioning unit for adjusting the shift lever between the non-use position and the use position thereof and/or vice versa, the positioning force generated by the positioning unit and acting on the shift lever can be at least reduced.

The particular advantage of the provision of an anti-trap unit is that the risk of injury to the user can be reduced as far as possible by reducing or deactivating the positioning force which acts on the shift lever and is generated by the positioning unit. The anti-trap unit makes it possible for a further, naturally occurring, movement of the shift lever to be prevented.

According to one preferred embodiment of the invention, the anti-trap unit has a coupling device which acts on the shift lever in such a way that the movement of the shift lever is stopped as a function of an actuating force acting on the shift lever. The actuating force is the force which the user exerts on the shift lever, or on a base part which carries the shift lever, during the movement of the shift lever. The magnitude of the actuating force which leads to the movement of the shift lever being stopped can be capable of being preset. This magnitude can be relatively low, with it being possible for only a touch of the shift lever or of its base part to lead to the shift lever movement being halted. The magnitude can, however, also be dependent on the level of the degree of coupling predefined by the coupling device, and lie in a range between zero and the level of the positioning force.

According to one preferred embodiment of the invention, the coupling device has a driving element which is coupled to the positioning unit and provides a positioning torque which is generated by the positioning unit. On the other hand, the coupling device has a driven element which is coupled to the shift lever and which is coupled to the driving element in such a way that the intended positioning force is exerted on the shift lever in the normal case of the shift lever movement. The driving element and the driven element are coupled to one another in such a way that, by actuating a counter-force of predefined magnitude, which acts counter to the movement of the shift lever, the driven element can be brought out of engagement with the driving element. The magnitude of the counter-force is dependent on the degree of coupling between the driving element and the driven element.

According to one refinement of the invention, the driven element and the driving element are connected to one another in a form-fitting manner in the normal position, with the degree of coupling being determined by the level of the form-fitting action. The out-of-engagement position between the driving element and the driven element is produced by a counter-force which acts on the shift lever and leads to a counter-torque of the driven element, which is greater than a predefined threshold torque whose level is dependent on the degree of form-fitting action between the driving and driven element.

According to another refinement of the invention, the driving element and the driven element have, on a side which faces toward one another, a corrugated profile, with a degree of elevation that determines the degree of coupling or the degree of form-fitting action. The degree of coupling can advantageously be preset in this way.

According to another refinement of the invention, the driving element and the driven element are arranged coaxially with respect to one another and in a common plane. The corrugated profile of the driven element and of the driving element extends in the peripheral direction along an outer and inner peripheral edge of the driving element and of the driven element. In this way, the coupling unit can be formed in a space-saving manner in or on a frame of the shift lever.

According to another refinement of the invention, the driven element has an actuating element which interacts with a switch which is fixedly arranged on a frame, in such a way that the positioning unit is deactivated when an end position of the shift lever is reached. It is advantageously possible in this way for the switch to be activated as a function of the end position of the shift lever.

According to another refinement of the invention, the switch is embodied as a pressure switch, wherein in connection with a control unit, the activation and deactivation of the positioning unit takes place always after a 180° rotation of the driven element.

According to yet another refinement of the invention, the driven element has an axial journal which is mounted in a guide slot of a base part of the shift lever. It is advantageously possible in this way for the rotational movement of the driven element to be converted into a linear movement of the shift lever.

Further advantages of the invention are apparent from the dependent claims.

An exemplary embodiment of the invention is explained in more detail below with reference to the drawings.

### BRIEF DESCRIPTION OF THE DRAWINGS

FIG. 1 is a perspective illustration of a shift lever arrangement according to the invention,

FIG. 2 shows a front view of the shift lever arrangement,

FIG. 3 shows a vertical section through the shift lever arrangement along a longitudinal central plane of a shift lever handle,

FIG. 4 shows a vertical section through the shift lever arrangement, transversely with respect to the vertical section of FIG. 3, along the shift lever, and

FIG. 5 shows a view of a driven element of the shift lever arrangement.

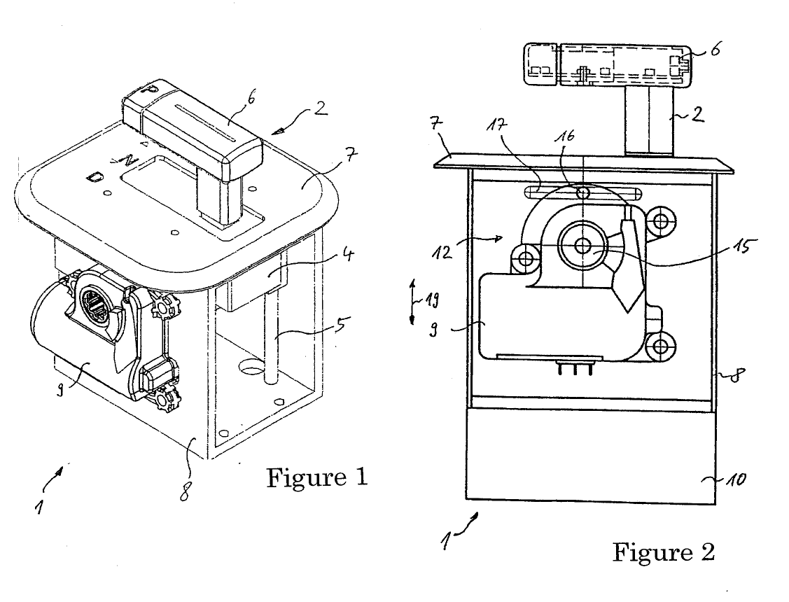

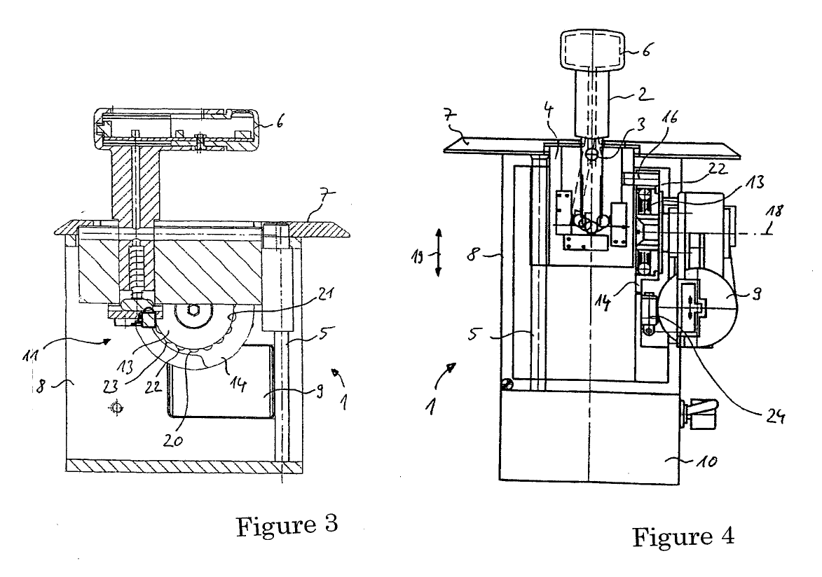

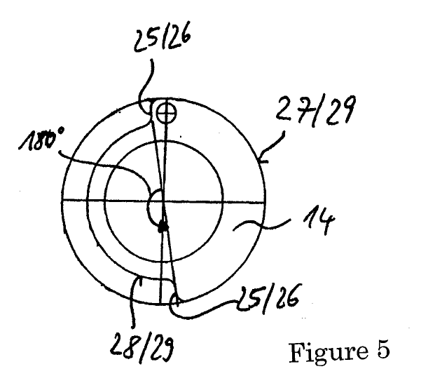

### DETAILED DESCRIPTION OF THE INVENTION

A shift lever arrangement 1 for a transmission of a motor vehicle is composed substantially of a shift lever 2 which is arranged, in a pivotable fashion by means of a joint 3, in a base part 4 of the shift lever 2. The base part 4 is guided, by means of a vertical guide 5, so as to be movable between an upper, use position of the shift lever 2, which is illustrated in the figures, and a lower, non-use position of the latter, in which an upper side of a handle 6 of the shift lever 2 is arranged flush with an upper side 7 of a frame 8 of the shift lever arrangement 1. For this purpose, a positioning unit 9 is provided which is preferably embodied as an electric motor and which is operatively connected to the base part 4 of the shift lever 2. The positioning unit 9 is connected to a control unit 10, which is preferably embodied as an electronic control unit comprising a microcontroller. The control unit 10 can activate the positioning unit 9 as a function of the actuation of an ignition starter switch, so that when the motor vehicle is started up, the shift lever 2, or the shift lever 2 together with the base part 4, can be automatically extended out of the non-use position into the use position. In the use position, the shift lever 2 serves to set shift stages of an automatic transmission. The automatic transmission can, in the conventional way, have a plurality of shift stages, such as for example parking (P), reverse (R), neutral (N) and forward (D).

In order to avoid a risk of injury to the user of the motor vehicle as a result of an automatic movement of the shift lever 2 from the use position into the non-use position and vice versa, an anti-trap unit 11 is provided which substantially has a coupling unit 12 comprising a driving element 13 and a driven element 14. The driving element 13 is fixedly connected to a driving shaft 15 of the positioning unit 9, so that a positioning torque is applied to the driving element 13 in the positioning state of the positioning unit 9. The driven element 14 is coupled to the base part 4 of the shift lever 2 and, in the positioning state, transmits the positioning torque which is applied to the driving element 13.

The driven element 14 has an axial journal 16 which is guided in a guide slot 17 of the base part 4. The guide slot 17 is preferably embodied as a horizontal longitudinal groove with a length that corresponds to the outer diameter of the driven element 14, as shown in FIG. 2. By rotating the circular-ring-shaped driven element 14 about a horizontal rotational axis 18, the base part 4 is moved in the vertical direction from the use position illustrated in FIG. 2 into the non-use position, in which the journal has been rotated 180° downward.

In the present exemplary embodiment, the base part 4 of the shift lever arrangement 1 is of square design and is arranged in a recess of the frame 8 so as to be movable in the vertical direction. In order to prevent the user of the motor vehicle from becoming trapped during the movement of the shift lever 2 (positioning state), the coupling device 12 is embodied in the manner of a slipping clutch. A plurality of balls 22 are mounted in the peripheral direction between an inner peripheral face 20 of the sleeve-shaped driven element 14 and an outer peripheral face 21 of the circular driving element 13. The inner peripheral face 20 of the driven element 14 and/or the outer peripheral face 21 of the driving element 13 has a corrugated profile 23 with troughs in which the balls 22 are mounted in each case. The balls 22 are supported, on a radially inwardly and/or radially outwardly aligned side, by springs (spiral springs). By changing the spring force of the spiral springs, it is possible for the degree of coupling between the driven element 14 and the driving element 13 to be influenced. In the positioning state of the shift lever arrangement 1, the positioning torque is transmitted directly from the driving element 13 to the driven element 14. The driving element 13 is in engagement with the driven element 14 via the balls 22. By linking the driven element 14 to the base part 4, it is possible to exert the positioning force required for moving the shift lever 2 between the non-use position and the use position and vice versa.

By applying an actuating force (counter-force) which acts counter to the positioning force, the driven element 14 can be brought out of engagement with the driving element 13, so that a further movement of the shift lever 2 in the preselected direction is prevented. The actuating force can be exerted by the user himself by pressing against the shift lever 2 or the base part 4 in the positioning state as the shift lever 2 is moving out of the recess of the frame 8, or by pulling on the shift lever 2 as the shift lever 2 is moving into the frame 8. To stop the movement of the shift lever 2, the actuating force (counter-force) must be so large that a threshold torque which acts counter to the positioning torque on the driven element 14 is exceeded. The magnitude of the threshold torque is dependent on the degree of coupling between the driving element 13 and the driven element 14. When the threshold torque is exceeded by the counter-torque, the driven element 14 “slips”, so that although the driving element 13 continues to rotate, the driven element 14 is at a standstill or even moves backward.

The deeper the troughs of the corrugated profile 23, or the greater the diameter of the balls 22 or the greater the spring force generated by the springs assigned to the balls 22, the greater the threshold torque and therefore the counter-force required for blocking the movement of the shift lever 2.

As can be seen from the figures, the driving element 13 and the driven element 14 are arranged coaxially with respect to one another and in a common vertical plane. The driving element 13 and the driven element 14 are arranged in a space-saving fashion within the frame 8. The axial journal 16 is arranged on a side, which faces away from the positioning unit 9, of the driven element 14, at which side the base part 4 adjoins the driven element 14 with play.

In order to detect the upper position (use position) and lower position (non-use position) of the shift lever 2, a switch 24 is provided which extends in the vertical direction below the driving element 13 and the driven element 14. The switch 24 is embodied as a pressure switch which has an upward-pointing metallic or non-metallic spring which interacts with an actuating element 25 of the driven element 14. The actuating element 25 of the driven element 14 is formed by radial elevations 26 of the driven element 14, which radial elevations 26 are arranged so as to be distributed at an angle of 180° about the rotational axis 18 of the driven element 14 and exert a compressive force or a compression-release force on the spring of the pressure switch 24. The radius of the driven element 14 is selected such that the driven element 14 performs a rotation of 180° during the movement from the non-use position into the use position and vice versa. A switching change therefore always takes place in the end positions of the shift lever 2. Only one pressure switch 24 is advantageously required as a result, since the switched signal and the non-switched signal of the switch 24 are used in the control unit 10 to move the shift lever 2 into an upper and lower end position respectively. A sliding face 27 and a recessed face 28 of the driven element 14, which sliding face 27 and recessed face 28 extend in each case in a circular fashion over 180°, are connected by means of opposing radial elevations 26 and form an outer peripheral face 29 of the driven element 14. Said sliding face 27 and recessed face 28 each have a constant radius.

As can be seen from FIG. 2, in the upper, use position of the shift lever 2, the axial journal 16 is arranged at a top dead center of the driven disk 14, so that a self-locking action is generated. It is therefore advantageously possible to prevent that, when the positioning unit 9 is not acted on, the shift lever 2 is moved out of the use position, or is moved downward into the recess of the frame 8, as a result of a force being exerted from above.

As described above, the driven element 14 is connected to the driving element 13 in a form-fitting manner by the balls 22, which are arranged so as to be distributed in the peripheral direction. According to an alternative embodiment which is not illustrated, the driven element 14 can also be coupled to the driving element 13 by other form-fitting connections such as, for example, by a spur gear transmission and the like. It is possible for the actuating force, which leads to the shift lever movement being stopped, to be so low that only a touch of the shift lever 2 or of the base part 4 stops the movement. For this purpose, a touch sensor is required which detects a touch of the shift lever 2 or of the base part 4 or of the frame 8 and sends a signal to the control unit 10 so that the control unit 10 transmits a stop signal to the positioning unit 9, by means of which stop signal the positioning unit 9 can be deactivated.

1-10. (canceled)

11. A shift lever arrangement for a transmission of a motor vehicle comprising:
a shift lever for setting a selected shift stage of the transmission,
a positioning unit by which the shift lever is mounted so as to be movable between a non-use position of the shift lever and a use position thereof for setting the shift stages, and
an anti-trap unit assigned to the shift lever so that, after activation of the positioning unit for adjusting the shift lever between the non-use position and the use position thereof, a positioning force generated by the positioning unit and acting on the shift lever can be at least reduced.

12. The shift lever arrangement as claimed in claim 11, wherein the anti-trap unit has a coupling device operating in such a way that the positioning force acting on the shift lever can be reduced or locked as a function of an actuating force exerted on the shift lever by the user.

13. The shift lever arrangement as claimed in claim 12, wherein the coupling device has both a driving element, which is coupled to the positioning unit and transmits a positioning torque, and a driven element, which is coupled to the shift lever, wherein the driving element is coupled to the driven element in such a way that, by actuating a predefined actuating force which acts counter to the movement of the shift lever, the driven element can be brought out of engagement with the driving element.

14. The shift lever arrangement as claimed in claim 13, wherein the driven element and the driving element are connected to one another in a form-fitting manner in a normal position, and wherein out-of-engagement positions of the driving element and the driven element are initiated when the counter-torque exerted by the actuating force exceeds a predefined threshold torque.

15. The shift lever arrangement as claimed in claim 13, wherein at least one of the driving element and the driven element is provided, on a side that faces toward the other, with a corrugated profile, in which a plurality of balls are mounted.

16. The shift lever arrangement as claimed in claim 15, wherein the driving element and the driven element are arranged coaxially with respect to one another and in a common plane, and wherein the corrugated profile extends in the peripheral direction along an outer peripheral edge of at least one of the driving element and along an inner peripheral face of that driven element.

17. The shift lever arrangement as claimed in claim 13, wherein the driven element has an actuating element, which interacts with a switch that is fixedly arranged on a frame, in such a way that the positioning unit is deactivated when an end position of the shift lever is reached.

18. The shift lever arrangement as claimed in claim 17, wherein switch is a pressure switch, and wherein the driven element has, at a peripheral edge, radial elevations that are arranged offset by 180°, with a radial extent of the driven element being constant between the radial elevations.

19. The shift lever arrangement as claimed in claim 13, wherein the driven element has an axial journal which is mounted in a guide slot of a base part of the shift lever.

20. The shift lever arrangement as claimed in claim 19, wherein the guide slot is a longitudinal groove.

21. The shift lever arrangement as claimed in claim 14, wherein at least one of the driving element and the driven element is provided, on a side that faces toward the other, with a corrugated profile, in which a plurality of balls are mounted.

22. The shift lever arrangement as claimed in claim 14, wherein the driven element has an actuating element, which interacts with a switch that is fixedly arranged on a frame, in such a way that the positioning unit is deactivated when an end position of the shift lever is reached.

23. The shift lever arrangement as claimed in claim 15, wherein the driven element has an actuating element, which interacts with a switch that is fixedly arranged on a frame, in such a way that the positioning unit is deactivated when an end position of the shift lever is reached.

24. The shift lever arrangement as claimed in claim 16, wherein the driven element has an actuating element, which interacts with a switch that is fixedly arranged on a frame, in such a way that the positioning unit is deactivated when an end position of the shift lever is reached.

25. The shift lever arrangement as claimed in claim 22, wherein switch is a pressure switch, and wherein the driven element has, at a peripheral edge, radial elevations that are arranged offset by 180°, with a radial extent of the driven element being constant between the radial elevations.

26. The shift lever arrangement as claimed in claim 23, wherein switch is a pressure switch, and wherein the driven element has, at a peripheral edge, radial elevations that are arranged offset by 180°, with a radial extent of the driven element being constant between the radial elevations.

27. The shift lever arrangement as claimed in claim 24, wherein switch is a pressure switch, and wherein the driven element has, at a peripheral edge, radial elevations that are arranged offset by 180°, with a radial extent of the driven element being constant between the radial elevations.

28. The shift lever arrangement as claimed in claim 14, wherein the driven element has an axial journal which is mounted in a guide slot of a base part of the shift lever.

29. The shift lever arrangement as claimed in claim 15, wherein the driven element has an axial journal which is mounted in a guide slot of a base part of the shift lever.

30. The shift lever arrangement as claimed in claim 17, wherein the driven element has an axial journal which is mounted in a guide slot of a base part of the shift lever.
